(19) United States
(12) Patent Application Publication
(10) Pub. No.: US 2025/0136823 A1
(43) Pub. Date: May 1, 2025

(54) ANTI-ICING FILM USING BROADBAND PLASMONIC METASURFACE IN WHICH ANISOTROPIC GOLD NANORODS AND CELLULOSE NANOCRYSTAL PARTICLES ARE CO-ASSEMBLED

(71) Applicant: Korea Advanced Institute of Science and Technology, Daejeon (KR)

(72) Inventors: Hyoungsoo KIM, Daejeon (KR); Dong Ki YOON, Daejeon (KR); Jeongsu PYEON, Daejeon (KR); Soon Mo PARK, Daejeon (KR)

(73) Assignee: Korea Advanced Institute of Science and Technology, Daejeon (KR)

(21) Appl. No.: 18/929,960

(22) Filed: Oct. 29, 2024

(30) Foreign Application Priority Data
Oct. 30, 2023 (KR) 10-2023-0146268
Aug. 14, 2024 (KR) 10-2024-0108894

(51) Int. Cl. C09D 5/03; B05D 3/04; B05D 5/08; C09D 7/20; C09D 7/61; C09D 7/65

(52) U.S. Cl. CPC C09D 5/032; B05D 3/046; B05D 5/08; C09D 7/20; C09D 7/61; C09D 7/65; B05D 2601/28; B05D 2602/00

(57) ABSTRACT

Provided are an anti-icing film using a broadband plasmonic metasurface produced by co-self-assembling anisotropic gold nanorods and cellulose nanocrystal, and a method for manufacturing the same. A method for manufacturing an anti-icing film including: (a) preparing an ink for an anti-icing film including a bonded body of the cellulose nanocrystal and the anisotropic gold nanorods and a binary mixed solution; (b) coating a substrate with the prepared ink; and (c) evaporating the binary mixed solution from the coated ink, and an anti-icing film manufactured therefrom may be provided. In addition, provided is an anti-icing film having anti-icing/deicing effect only with light irradiation of a visible light wavelength, by including a substrate; and a film layer including a metasurface on the substrate, wherein the metasurface includes a composite arranged in a certain direction, in which the anisotropic gold nanorods and the cellulose nanocrystal particles are co-assembled.

### CROSS-REFERENCE TO RELATED APPLICATIONS

This application claims priority under 35 U.S.C. § 119 to Korean Patent Application No. 10-2023-0146268, filed on Oct. 30, 2023, and Korean Patent Application No. 10-2024-0108894, filed on Aug. 14, 2024, in the Korean Intellectual Property Office, the disclosure of which is incorporated herein by reference in its entirety.

### TECHNICAL FIELD

The following disclosure relates to an anti-icing film using a broadband plasmonic metasurface in which anisotropic gold nanorods and cellulose nanocrystal particles are co-self-assembled, and a method for manufacturing the same.

### BACKGROUND

Recently, various aspects of nano-sized functional particles have been studied for their transparency due to their small particle size, strong interaction between a substrate and a coating material, solidity of a coating layer, and the like. In particular, precious metal nanoparticles such as gold or silver are being widely studied and applied, and the precious metal nano-sized particles cause a surface plasmonic resonance phenomenon in which free electrons inside metal particles vibrate collectively, when being exposed to light in a broadband visible light region. Due to the plasmonic resonance effect, optical/thermal/electrical properties are freely controlled by adjusting the wavelength region and polarization direction of incident light or controlling the shape and size of metal particles. Due to the advantages, studies are actively being conducted in order to use the effect in various industrial fields.

For example, the particles are being studied as a photothermal therapy means which is used as a CT contrast medium using scattering properties of gold nanorods to diagnose cancer cells or kill cancer cells using a plasmonic photothermal effect of gold nanorods, in the bioindustry field. In addition, in order to improve energy conversion efficiency in the solar cell field, the metal nanoparticles are coated, and used as a cosmetic component for securing dermoprotective and antioxidant activities and also applied to a functional film for anti-icing and defogging.

However, since the previous studies include a process of adding polymer or use a self-assembled monolayer (SAM) deposition method or a layer-by-layer self-assembly method, the process is complicated.

In addition, when a process of evaporating a solvent is used, droplets on a solid substrate are evaporated, and a non-uniform drying pattern in a ring shape, which is called a coffee-ring effect, is formed due to a non-uniform evaporation rate distribution occurring along a liquid-gas interface of the droplets. The non-uniform deposition pattern impairs plasmonic performance of gold nanorods.

Therefore, it is urgent to secure technical skills for uniformly depositing gold nanoparticles and also extinguishing the coffee-ring effect.

### SUMMARY

An embodiment of the present disclosure is directed to providing an anti-icing film which has excellent heating efficiency even under a light irradiation condition in a visible light region by using a metasurface in which a composite of cellulose nanocrystal particles and anisotropic gold nanoparticles is oriented parallel to a circumferential direction on a quadrant of a film layer.

Another embodiment of the present disclosure is directed to providing an ink for manufacturing an anti-icing film which is manufactured by a simple evaporation process without performing an expensive and complicated process.

Another embodiment of the present disclosure is directed to providing a method for manufacturing an anti-icing film which allows spontaneous formation of a pattern in which a composite of cellulose nanocrystal particles and anisotropic gold nanoparticles is oriented parallel to a circumferential direction on a quadrant of a film layer by a simple evaporation process.

Still another embodiment of the present disclosure is directed to providing a method for manufacturing an anti-icing film which allows the film to be mass produced, have high uniformity, and be manufactured by a simple process.

In one general aspect, an ink for an anti-icing film includes: cellulose nanocrystal particles, anisotropic gold nanorods, and a binary mixed solution.

According to an exemplary embodiment of the present disclosure, the binary mixed solution includes a first solvent and a second solvent, and the first solvent and the second solvent may satisfy the following Equation 1 and Equation 2:

$${P}_{1} / {P}_{2} > 5 \qquad [ Equation 1 ]$$

$${γ}_{1} / {γ}_{2} > 3 \qquad [ Equation 2 ]$$

wherein P₁ and P₂ are vapor pressures at 20° C. of the first solvent and the second solvent, respectively, and a unit of the vapor pressure is kPa; and γ₁ is a surface tension value of a solvent having a higher surface tension of the first solvent and the second solvent, γ₂ is a surface tension value of a solvent having a lower surface tension of the first solvent and the second solvent, the surface tension value is surface tension at 25° C., and a unit of the surface tension is mN/m.

According to an exemplary embodiment of the present disclosure, an ink for an anti-icing film in which the first solvent includes methanol, and the second solvent includes water may be provided.

According to an exemplary embodiment of the present disclosure, an ink for an anti-icing film in which the ink satisfies the following Equation 3 in the entire area section of evaporation time may be provided:

$$\vert {U}_{d} / {U}_{c} \vert \geq 1 \qquad [ Equation 3 ]$$

wherein U_{d} is a dewetting speed of a contact line between an ink droplet and a substrate after dropping the ink onto a solid substrate by a drop-casting method, and U_{c} is a coffee-ring flow speed in a contact surface between the ink droplet and the substrate after dropping the ink onto the solid substrate.

According to an exemplary embodiment of the present disclosure, an aspect ratio of the anisotropic gold nanorods may be 2 to 9.

According to an exemplary embodiment of the present disclosure, an aspect ratio of the cellulose nanocrystal particles may be 2 to 30.

In another general aspect, a method for manufacturing an anti-icing film includes:
(a) preparing the ink of any one of claims 1 to 6;
(b) coating a substrate with the prepared ink; and
(c) evaporating a binary mixed solution from the coated ink.

According to an exemplary embodiment of the present disclosure, the ink of (a) may include 1.0 to 10.0 wt % of cellulose nanocrystal.

According to an exemplary embodiment of the present disclosure, the ink of the step (a) may include 0.01 to 1.0 wt % of anisotropic gold nanorods.

According to an exemplary embodiment of the present disclosure, the method of coating a substrate with the ink may be performed by a method selected from the group consisting of spin coating, spray coating, dip coating, drop-casting, inkjet printing, nozzle printing, slot die coating, roll-to-roll printing, doctor blade coating, screen printing, and combinations thereof.

According to an exemplary embodiment of the present disclosure, in the drying step, the anisotropic gold nanorods may be self-assembled to the cellulose nanocrystal to form a pattern of being uniformly aligned in a growth ring shape on a quadrant of the film.

According to an exemplary embodiment of the present disclosure, the drying step may be performed at room temperature under normal pressure.

According to an exemplary embodiment of the present disclosure, after the step (c), forming a waterproof layer may be further included.

In still another general aspect, an anti-icing film includes: a substrate; and a film layer including a metasurface on the substrate, wherein the metasurface includes a composite arranged in a certain direction, in which anisotropic gold nanorods and cellulose nanocrystal particles are co-assembled.

According to an exemplary embodiment of the present disclosure, the metasurface may have a pattern in which the composite of the cellulose nanocrystal particles and the anisotropic gold nanorods is oriented parallel to a circumferential direction (growth ring shape) on the quadrant of the film layer.

According to an exemplary embodiment of the present disclosure, the cellulose nanocrystal: the anisotropic gold nanorods may be included at a weight ratio of 1:0.001 to 1:1.

According to an exemplary embodiment of the present disclosure, the anti-icing film may be heated only by light irradiation in a visible light region.

According to an exemplary embodiment of the present disclosure, the anti-icing film satisfying the following Equation 4 may be provided:

$$1 < \frac{Te}{Tc} < 2 \qquad [ Equation 4 ]$$

wherein Te is a thickness at an edge of the obtained film, and Tc is a thickness at the center of the obtained film.

Other features and aspects will be apparent from the following detailed description, the drawings, and the claims.

### BRIEF DESCRIPTION OF THE DRAWINGS

FIG. 1 is results of TEM measurement of cellulose nanocrystal and anisotropic gold nanorods used in the present invention.

FIG. 2 is a schematic diagram for describing a dewetting speed U_{d} and a coffee-ring flow speed U_{c} when a binary mixed solution evaporates from the ink of the present invention.

FIG. 3 schematically shows a process of manufacturing an ink for an anti-icing film.

FIG. 4 is a schematic diagram showing an ink droplet evaporation hydrodynamic mechanism during a process in which the binary mixed solution evaporates from the ink of the present invention.

FIG. 5 is results of measuring an ink droplet evaporation hydrodynamic mechanism with a particle image flow meter during an evaporation process.

FIG. 6 is a polarizing light microscope image of the anti-icing film of the present invention and a polarized image with retardation plate insertion at 45°

FIG. 7 shows a polarized image in which the cellulose nanocrystal particles are self-assembled during a process of binary mixed solution evaporation.

FIG. 8A shows results of measuring change in |U_{d}/U_{c}| depending on a binary mixed solution composition.

FIG. 8B shows results film thickness depending on a binary mixed solution composition.

FIG. 9 shows results of measuring |U_{d}/U_{c}| during a process in which the binary mixed solution evaporates from the ink of the present invention.

FIG. 10 shows a measurement profile of a thickness of the anti-icing film of the present invention.

FIG. 11 shows results of observing an optical metasurface of the anti-icing film of the present invention.

FIG. 12 shows results of atomic force microscope (AFM) analysis of the cellulose nanocrystal particles self-assembled during the process of binary mixed solution evaporation (AFM images (upper) and rotation distribution (lower) in the (i) inside, (ii) middle, (iii) 40° direction near a contact line).

FIG. 13 shows results of scanning electron microscope-backscattered electron (SEM-BSE) analysis of the anti-icing film of the present invention ((a) representative SEM image of gold nanorod particles, (b) SEM (upper) and BSE (lower) images (i) in the inside, (ii) in the middle, (iii) near the ring of the cellulose nanocrystal/gold nanorod film).

FIG. 14 shows a thermal metasurface for anti-icing of the anti-icing film of the present invention.

FIG. 15 shows anti-icing and deicing test results of the anti-icing film of the present invention.

FIG. 16 is results of a waterproof test of the anti-icing film of the present invention further including a waterproof layer.

FIG. 17A shows graphs of (a) a temperature rise of a CNC-GNR film under a light irradiation of about 356.5 mW/cm², when a concentration of metal nanorods (GNR) included is 00132 wt %, 0.00346 wt %, 0.03462 wt %, and 0.34515 wt %.

FIG. 17B shows a temperature rise depending on light intensity, when the anisotropic gold nanorods (GNR) are included at 0.35 wt %.

FIG. 18 shows a photograph of an achromatic (black) film surface, when the anisotropic gold nanorods (GNR) are included at 3.38 wt %.

FIG. 19 is infrared camera photographs showing a temperature rise of CNC-GNR film under a light irradiation of about 356.5 mW/cm², as photothermal performance evaluation of the films of Examples 3 and 4.

FIG. 20 shows a polarized microscope image of Comparative Example 3 without the retardation plate and a polarized microscope image of Comparative Example 3 with the retardation plate inserted.

FIG. 21 shows results of measuring a film temperature with an infrared camera before irradiating the film of Comparative Example 3 with light of 500±50 mW/cm² and after irradiating the film with the light for 60 seconds.

FIG. 22A shows a wavelength spectrum of a light source used in Experimental Examples 3 and 4.

FIG. 22B a wavelength spectrum of a light source used in Experimental Example 5.

FIG. 23A shows graphs of a temperature change in a CNC-GNR film under a light irradiation of about 191.0 mW/cm², when a concentration of metal nanorods (GNR) included is 0.0132 wt %, 0.00346 wt %, 0.03462 wt %, and 0.34515 wt %.

FIG. 23B show a temperature rise of a film depending on light source intensity of used in Experimental Example 5.

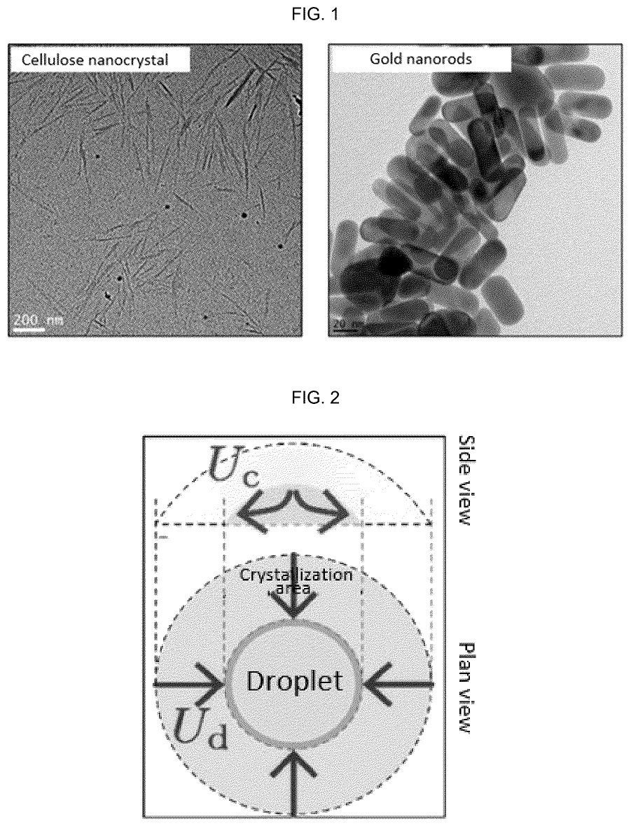

### DETAILED DESCRIPTION OF EMBODIMENTS

Advantages and features of the present disclosure and methods of achieving them will become apparent from the following detailed description of exemplary embodiments. However, the present disclosure is not limited to exemplary embodiments disclosed below but will be implemented in various forms. The exemplary embodiments of the present disclosure make the present Initiator disclosure thorough and are provided so that those skilled in the art can easily understand the scope of the present invention. Therefore, the present disclosure will be defined only by the scope of the appended claims.

Unless otherwise defined herein, all terms used herein (including technical and scientific terms) may have the meaning that is commonly understood by those skilled in the art.

The singular form of the term used herein may be intended to also include a plural form, unless otherwise indicated.

The numerical range used in the present specification includes all values within the range including the lower limit and the upper limit, increments logically derived in a form and spanning in a defined range, all double limited values, and all possible combinations of the upper limit and the lower limit in the numerical range defined in different forms. Unless otherwise defined in the specification of the present disclosure, values which may be outside a numerical range due to experimental error or rounding off of a value are also included in the defined numerical range.

The term “comprise” mentioned in the present specification is an open-ended description having a meaning equivalent to the term such as “is/are provided”, “contain”, “have”, or “is/are characterized”, and does not exclude elements, materials, or processes which are not further listed. In addition, singular forms are intended to include plural forms unless otherwise indicated explicitly in the context.

Hereinafter, units used without particular mention are based on weights, and as an example, a unit of % or ratio refers to a wt % or a weight ratio.

In addition, in describing constituent elements of the present invention, terms such as first, second, A, B, (a), and (b) may be used. These terms are used only to differentiate the constituent elements from other constituent elements, and the nature, sequence, order, or the like of the corresponding constituent elements is not limited by these terms.

When an element such as a layer, a film, a thin film, region, or substrate mentioned in the present specification is referred to as being “on” or “above” the other element, it includes the case of an intervening element being present therebetween as well as the case of the element being “directly on” the other element.

Hereinafter, an anti-icing film using a broadband plasmonic metasurface of the present disclosure in which anisotropic gold nanorods and cellulose nanocrystal particles are co-assembled will be described in detail. However, it is only illustrative and the present disclosure is not limited to the specific embodiments which are illustratively described in the present disclosure.

Recently, due to unusual weather around the world and the like, in order to prevent icing on windows of automobiles, aircraft, and residential/commercial spaces, and the like by low temperatures in winter, methods such as using a heating wire or heater, or periodically applying a spray and oil including an anti-icing composition are used.

However, when a heating wire is used for anti-icing, a fire hazard is increased and regular checks for leakage, overheating, and the like are needed, and though the spray or oil may be temporarily effective, it may be easily lost depending on an environment.

Therefore, the inventors of the present disclosure invented an anti-icing film which may raise a temperature through a spontaneous heat energy harvesting effect of converting solar energy into heat energy, using a broadband plasmonic metasurface of an aggregate in which anisotropic gold nanorods (GNR) and cellulose nanocrystal particles (CNC) which are environmentally friendly materials are co-assembled, and a method for manufacturing the same.

The present disclosure may provide an anti-icing film including: a substrate; and a film layer including a metasurface on the substrate, wherein the metasurface includes a composite arranged in a certain direction, in which anisotropic gold nanorods and cellulose nanocrystal particles are co-assembled.

The substrate may be materials of various solid substrates, such as glass, metal, and plastic, may be a substrate having various curved shapes as well as substrates having a simple flat shape, and may be used without limitation as long as it has a surface for anti-icing, such as windows of automobiles and aircraft. More specifically, the substrate is not limited as long as it is a solid substrate which may be coated with an ink including a hydroxyl (—OH) group, and the solid substrate may have a thickness of less than 1 μm and may be a flexible substrate.

Since the cellulose nanocrystal particles have a large surface area and high dispersibility characteristics, they are not limited as long as gold nanoparticles may be uniformly deposited. Specifically, they may be cellulose nanocrystal particles which are obtainable from nature, renewable, biodegradable, non-toxic, and low-cost, and may not be surface-modified or be surface-modified. The cellulose nanocrystal particles may be cellulose nanocrystal particles, or cellulose formed of at least one basic fibril mainly including a crystalline or paracrystalline region which does not show branches or entanglement between network type structures, and also, the cellulose nanocrystal particles may be a fiber, nanowire, or nanorod form, but is not necessarily limited thereto.

The metasurface refers to a two-dimensional structure showing a new property (for example, optical properties) other than physical properties present in nature, that is, a two-dimensional flat structure which is a newly made thin film using a pattern smaller than a light wavelength.

In an exemplary embodiment of the present disclosure, the cellulose nanocrystal particles and the anisotropic gold nanorods may have a co-assembled composite form.

The cellulose nanocrystal may bond the anisotropic gold nanorods to the surface of the cellulose nanocrystal (co-assembly) due to a negative charge occurring on the surface during hydrolysis, and may form a composite form in which the cellulose nanocrystal particles and the anisotropic gold nanorods are co-assembled.

The anisotropic gold nanorods have surface plasmon resonance in transverse and longitudinal directions due to a self-anisotropic structure when light is incident from outside. Since light is absorbed due to high photoreactivity according to the localized surface plasmon resonance (LSPR) properties and the absorbed light may be converted into heat energy, a photothermal effect may be shown. In addition, since the cellulose nanocrystal has excellent dispersibility due to a high aspect ratio and hydrophilicity, cellulose nanocrystal may be dispersed in forming a metasurface in the film.

The anisotropic gold nanorods have high entropy and excluded volume effect, a degree of freedom of gold nanorods is maximized and the anisotropic gold nanorods may be oriented parallel to the cellulose nanocrystal particles due to the nature of not sharing the same space with the cellulose nanocrystal particles. Therefore, when the anisotropic gold nanorods and the cellulose nanocrystal particles are used as metamaterials, a cellulose nanocrystal-gold nanorod composite may be parallel and uniformly oriented on the substrate.

In addition, when the cellulose nanocrystal is used as a matrix of the anti-icing film, mechanical strength and thermal stability may be significantly improved, and since the cellulose nanocrystal (CNC) shows absorption properties in a visible light region as well as in an infrared region, and absorbs and scatters light due to the nanostructure, it may improve a photothermal effect.

According to an exemplary embodiment of the present disclosure, a content ratio of the anisotropic gold nanorods:the cellulose nanocrystal particles may be in a range of 1:0.001 to 1:1. Specifically, the content ratio may be in a range of 1:0.05 to 1:1 or 1:0.1 to 1:1.

Within the range, the higher the content of the added cellulose nanocrystal particles, the higher the transparency and the optical clarity of the anti-icing film, and the film may be used in various uses such as a glass window.

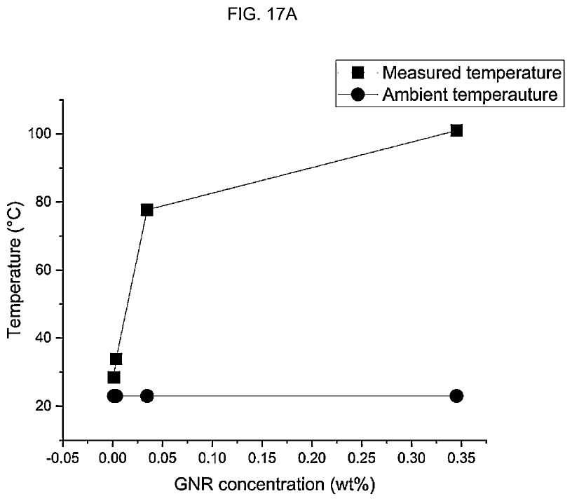

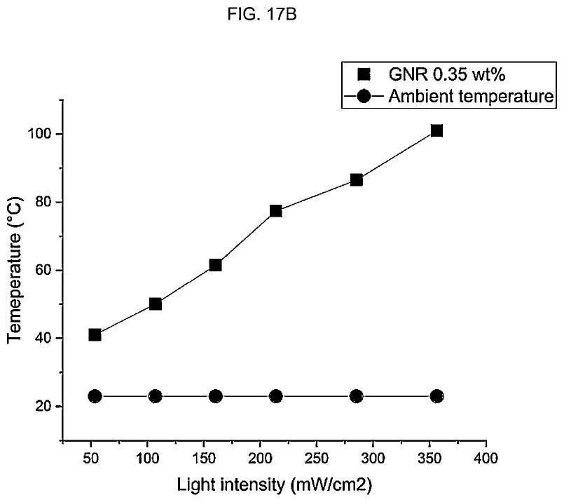

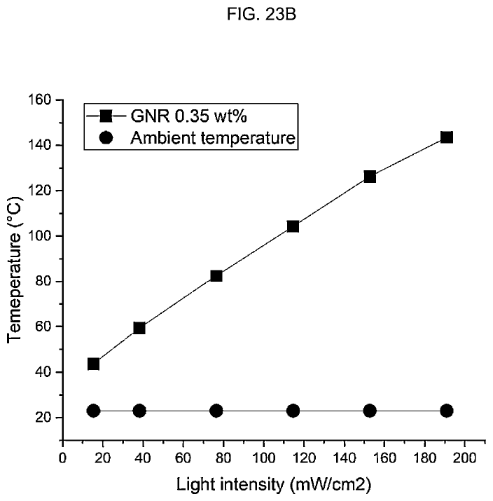

In addition, as the content of the anisotropic gold nanorods is increased, a localized surface plasmon resonance (LSPR) phenomenon may actively occur to improve a heating effect, and since the film layer is achromatic (black) and absorbs all lights in a visible light region of 300 nm to 800 nm, an absorption rate of visible light may be increased to amplify the heating effect. In addition, as the content of the anisotropic gold nanorods is increased, the temperature rises to 100° C. or higher when the film is irradiated with visible light, as shown in (a) of FIGS. 17 and 23, and thus, the content of GNR may be added in an appropriately controlled manner depending on the use of the anti-icing film.

That is, the contents of the cellulose nanocrystal and the anisotropic gold nanoparticles are appropriately controlled depending on where the anti-icing film is used, thereby providing a transparent or translucent achromatic (black) anti-icing film.

In an exemplary embodiment of the present disclosure, the metasurface may have a pattern in which the composite of the cellulose nanocrystal particles and the anisotropic gold nanorods is oriented parallel to a circumferential direction (growth ring shape) on the quadrant of the film layer.

As shown in FIG. 4, when the composite of the cellulose nanocrystal particles and the anisotropic gold nanorods on the metasurface is oriented in the circumferential direction and has a circular ring pattern, the plasmon photothermal effect may be improved.

In an exemplary embodiment of the present disclosure, an aspect ratio of the anisotropic gold nanorods may be in a range of 2 to 9. Specifically, a size of the anisotropic gold nanorods may have a length of 5 to 40 nm, 5 to 35 nm, 5 to 30 nm, 10 to 30 nm, 10 to 25 nm, 10 to 20 nm, or 15 to 20 nm, and more specifically, may be 10 to 20 nm, in a short axis direction, and may be a value between in the range, but is not necessarily limited thereto.

In addition, the size of the anisotropic gold nanorods may have a length of 20 to 200 nm, 20 to 150 nm, 20 to 100 nm, 35 to 100 nm, 40 to 100 nm, 45 to 100 nm, 50 to 100 nm, 50 to 90 nm, 50 to 85 nm, or 50 to 80 nm, and more specifically, 50 to 100 nm, in a long axis direction, and may be a value between in the range, but is not necessarily limited thereto.

Specifically, the aspect ratio of the anisotropic gold nanorods may be 1 or more, 2 or more, 3 or more, 5 or more, 6 or more and up to 10, more specifically, 2 to 9, and more specifically, 3 to 6.

The gold nanorods satisfying the range of the aspect ratio has a large scattering effect due to the anisotropic structure and the surface of the gold nanorods may have plasmon resonance. An optical metasurface in which optical properties are controlled depending on the polarization and polarization angle of incident light may be formed, and the plasmon resonance band (longitudinal band) of the gold nanorods may be controlled to a wavelength band in the visible light region. In addition, the anisotropic gold nanorods may be uniformly bonded to the cellulose nanocrystal, and the anisotropic gold nanorods deposited on the cellulose nanocrystal may be co-self-assembled in a short time.

In an exemplary embodiment of the present disclosure, the anti-icing film may emit heat in the visible light region.

In the present disclosure, the gold nanorods causes a localized surface plasmon resonance (LSPR) phenomenon in the wavelength band in the visible light region. That is, the anti-icing film by the composite of the anisotropic gold nanorods and the cellulose nanocrystal of the present disclosure may cause a plasmon resonance phenomenon in the wavelength in the visible light region as well as in the infrared region. Therefore, an unusual effect of amplifying a heating effect even in the wavelength band in the visible light region, that is, in the wavelength band of 300 nm to 900 nm, occurs due to overlapping of a light absorption spectrum of the cellulose nanocrystal which absorbs light in the visible light region and a plasmon resonance band spectrum of the anisotropic gold nanorods, and the photothermal effect may be improved even in a natural light irradiation environment. However, the present disclosure is not necessarily limited thereto, and when a film is formed identically by replacing the gold nanorods with anisotropic gold nanorods having an aspect ratio of about 4 or more which strongly generate plasmon resonance in the wavelength band in the near infrared region, a film operated also by light in the near infrared wavelength band may be manufactured.

Therefore, the anti-icing film of the present disclosure may raise a surface temperature of the anti-icing film when light in the visible light region is irradiated. That is, the anti-icing film of the present disclosure may show excellent anti-icing and deicing performance by maintaining a temperature of 0° C. or higher even at or below a freezing temperature of the substrate due to the high absorbance in the visible light region. More specifically, an excellent anti-icing effect of maintaining the temperature of 5 to 8° C. even on a solid substrate cooled to −8° C. may be shown. That is, a plasmonic effect is amplified in light in the broad visible wavelength region as well as in the infrared region, so that the anti-icing effect at a low temperature is excellent even by a natural light level.

In an exemplary embodiment of the present disclosure, the anti-icing film may further include a waterproof layer on the film layer.

A material forming the waterproof layer is not limited as long as it may impart waterproof properties. Specifically, the waterproof layer may be formed of an impermeable material. “Impermeable” means that water, moisture, and humidity do not substantially pass through or penetrate, and the impermeable material may be nonporous and/or porous. When the impermeable material is a porous material, a minimum size of pores may be smaller than the minimum size of droplets of water, moisture, and humidity.

Otherwise, a material forming the waterproof layer may have an oil or wax component having hydrophobic properties while the gold nanorods and the cellulose nanocrystal are not dispersed. Since the oil or wax has lipophilic properties of not mixing with moisture, it may have hydrophobic properties. Specifically, the oil may include at least one of fluorinated carbon oil, silicon oil, carbon-based oil, and fatty acid amide, and may be a manicure oil (Lucid Nail Polish, MISSHA, KOREA).

By further including the waterproof layer in the anti-icing film, the pattern formed by the anisotropic gold nanorods may have improved water resistance. FIG. 16 is results of a waterproof test of the anti-icing film of the present invention further including a waterproof layer. Referring to FIG. 16, in the case in which the waterproof layer is not included on the surface of the film, when the film is exposed to moisture, the pattern in which the cellulose nanocrystal and the anisotropic gold nanorods are co-self-assembled may be deformed, but in the case in which the waterproof layer is included, the pattern formed by the anisotropic gold nanorods is not deformed and is fixed even when the film is exposed to the moisture, thereby providing a film having improved durability.

Thus, the anti-icing film of the present disclosure may be a more environmentally friendly anti-icing film which may raise a temperature even in a natural light irradiation environment, by using the broadband plasmonic metal of an aggregate in which the anisotropic gold nanorods (GNR) and the cellulose nanocrystal particles (CNC) which are an environmentally friendly material are co-assembled.

Hereinafter, the method for manufacturing an anti-icing film of the present disclosure will be described in detail with reference to the attached drawings. The size, aspect ratio, and the like of the anisotropic gold nanorods and the cellulose nanocrystal used in the manufacturing method are as described above.

The present disclosure may provide a method for manufacturing an anti-icing film including: (a) preparing an ink for an anti-icing film; (b) coating a substrate with the prepared ink; and (c) evaporating a binary mixed solution from the coated ink.

First, the ink for an anti-icing film will be described in detail. The anti-icing film of the present disclosure may be manufactured using the ink for an anti-icing film which will be described in detail, hereinafter.

In an exemplary embodiment of the present disclosure, the ink for an anti-icing film of step (a) may include cellulose nanocrystal particles, anisotropic gold nanorods, and a binary mixed solution. Since the cellulose nanocrystal particle and the anisotropic gold nanorods are as described above for the anti-icing film, detailed description thereof will be omitted.

In an exemplary embodiment of the present disclosure, a content of the cellulose nanocrystal particles included in 100 wt % of the ink for an anti-icing film including the binary mixed solution may be 1 wt % or more, 1.5 wt % or more, 2 wt % or more, or 2.5 wt % or more and 10 wt % or less, 9 wt % or less, 8 wt % or less, 7 wt % or less, 6 wt % or less, 5 wt % or less, or 4 wt % or less, or a value between those values.

Specifically, it may be 1.0 to 10.0 wt %, 1.5 to 7.0 wt %, 2.0 to 6.0 wt %, 2.0 to 5.0 wt %, or 2.2 to 4.5 wt %. More specifically, it may be 2 to 4 wt %.

when the cellulose nanocrystal particles at the content are included in the ink for an anti-icing film, the anisotropic gold nanorods may be uniformly bonded to the cellulose nanocrystal particles, and the nanocrystal and the anisotropic gold nanorods may be co-self-assembled more easily and uniformly, so that a distinct circular pattern may be formed even in the center. Finally, the anti-icing film in which the aggregate of the cellulose nanocrystal particles and the anisotropic gold nanorods is uniformly aligned on the quadrant of the anti-icing film may be formed.

In an exemplary embodiment of the present disclosure, the content of the anisotropic gold nanorods included in 100 wt % of the ink for an anti-icing film may be 1 wt % or less. It may be specifically 0.01 to 1.0 wt %, still more specifically 0.05 to 0.9 wt %, or 0.09 to 0.7 wt %.

Referring to FIG. 17A, it is confirmed that the higher the concentration of the anisotropic gold nanorods (GNR) is, the higher the plasmonic photothermal performance is, and in the case of adding 0.035 wt % of GNR, when the film is irradiated with light having an intensity of about 356 mW/cm², a film temperature reaches to a high temperature of 100° C. Referring to FIG. 17B, it is confirmed that as the light intensity increases, the film temperature shows a linear temperature increase/decrease pattern. Therefore, the content of the anisotropic gold nanorods may be appropriately adjusted depending on the field where the anti-icing film is used, such as automobile frost, aircraft, and windows of residential/usage spaces.

When the content of the anisotropic gold nanorods included in the ink for an anti-icing film is satisfied, the gold nanorods may be uniformly bonded to the cellulose nanocrystal particles, and may be uniformly aligned on the quadrant of the anti-icing film with the cellulose nanocrystal particles. In addition, the plasmon effect of the anisotropic gold nanorods may be maximized, and an effect of a temperature rise of the anti-icing film may be obtained on a solid substrate.

In an exemplary embodiment of the present disclosure, the binary mixed solution includes a first solvent and a second solvent, and the first solvent and the second solvent may satisfy the following Equations 1 and 2:

$${P}_{1} / {P}_{2} > 5 \qquad [ Equation 1 ]$$

$${γ}_{1} / {γ}_{2} > 3 \qquad [ Equation 2 ]$$

wherein P₁ and P₂ are vapor pressures at 25° C. of the first solvent and the second solvent, respectively, and a unit of the vapor pressure is kPa; and γ₁ is a surface tension value of a solvent having a higher surface tension of the first solvent and the second solvent, γ₂ is a surface tension value of a solvent having a lower surface tension of the first solvent and the second solvent, the surface tension value is surface tension at 25° C., and a unit of the surface tension is mN/m.

Since the binary mixed solution including solvents satisfying Equations 1 and 2 includes two solvents having a big difference in evaporation rates, phase separation between the first solvent/the second solvent occurs due to selective evaporation of the first solvent having high volatility during an evaporation process, and Marangoni stress is generated by a Marangoni effect due to a difference in surface tension of the two solvents. As a result, a spontaneous and rapid dewetting phenomenon occurs after a Marangoni flow is formed, and dewetting movement in a droplet center direction may align the cellulose nanocrystal particles parallel to a contact line spontaneously.

Herein, the Marangoni effect refers to an effect of a liquid moving from an area of low surface tension to an area of high surface tension, when a surface tension magnitude is not constant along an interface due to the temperature difference and concentration of the liquid, mixing with other liquids, or the like.

More specifically, vapor pressures of the first solvent and the second solvent may be higher than 3 kPa, respectively. When an anti-icing film is manufactured using the binary mixed solution satisfying the conditions, a circular metasurface may be formed only by simple drying under room temperature/normal pressure evaporation conditions. That is, since the metasurface having a uniform pattern may be formed without a complicated manufacturing process, mass production is allowed at low costs. However, the present disclosure is not necessarily limited thereto, and when a solvent having a vapor pressure of lower than 3 kPa is used, drying is allowed within 10 to 20 minutes by controlling surrounding pressure and temperature conditions in a drying step.

In addition, the first solvent and the second solvent may include two or more solvents. For example, they may be a solvent including not only pure methanol, but also methanol and ethanol which mixes well with methanol or methanol and isopropyl alcohol (IPA), but these are only examples and the present disclosure is not necessarily limited thereto.

In addition, when the solvent satisfying Equations 1 and 2 is a nonpolar solvent, cellulose nanocrystal having a modified surface may be used for increasing dispersibility of the cellulose nanocrystal particles (CNC).

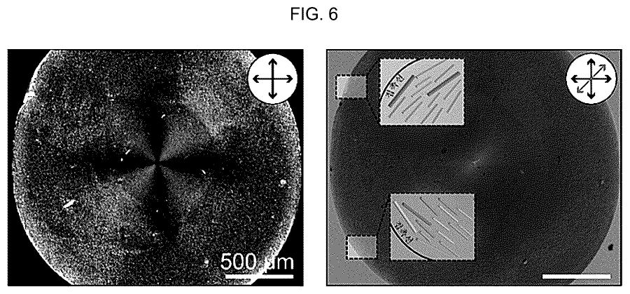

Therefore, the cellulose nanocrystal particles are self-assembled near the contact surface by the tendency in which molecules of the first solvent move to the contact line through simple evaporation in which the first solvent having high vapor pressure evaporates selectively and rapidly, and a behavior in which the anisotropic gold nanorods are bonded to the cellulose nanocrystal particles during a process of self-assembling of the cellulose nanocrystal particles and co-self-assembled may be shown. Herein, the contact line refers to an edge line of an ink in contact with a substrate, as shown in FIG. 6.

More specifically, in an exemplary embodiment of the present disclosure, the binary mixed solution satisfying Equations 1 and 2 included in the ink for an anti-icing film may include two solvents having a big difference in volatilization rates and surface tension magnitudes, such as water and methanol. Since methanol may disperse the cellulose nanocrystal particles well and water is readily available, costs may be reduced in the manufacture of the anti-icing film. However, water and methanol are only examples of the solvent satisfying Equations 1 and 2, and the present disclosure is not necessarily limited thereto.

In an exemplary embodiment of the present disclosure, the ink for an anti-icing film may satisfy the following Equation 3 in the entire area section of an evaporation time:

$$\vert {U}_{d} / {U}_{c} \vert \geq 1 \qquad [ Equation 3 ]$$

wherein U_{d} is a dewetting speed of a contact line between an ink droplet formed after dropping the ink onto a solid substrate and a substrate, and U_{c} is a coffee-ring flow speed in a contact surface between the ink droplet formed after dropping the ink onto the solid substrate and the substrate.

The dewetting speed U_{d} is a result obtained by observing a bottom view of CNC or CNC-GNR solution droplets which evaporates in real time through a polarization microscope (POM, Nikon Eclipse Ti2-E microscope, and DS-Ri2 detector, Japan) and calculating a speed of the contact line moving in real time [=dewetting speed (U_{d})(ΔR/Δt)]. Herein, R is a radius of the droplets, and t is time elapsed.

The coffee-ring flow is a flow directed from a droplet center to a droplet contact line for conserving a relatively large solution loss occurring near the contact line (edge) due to the much larger evaporation rate near the contact line (edge) than near the top of the droplets, and is an inevitably occurring phenomenon.

The coffee-ring flow speed U_{c} was measured based on the actual distance and time traveled by the corresponding particles after adding fluorescent polystyrene particles (PS-FluoRed-Fi320, micro-particles GmbH, Germany) having a diameter of 1.90±0.09 μm at a concentration of 1% v/v to CNC or CNC-GNR droplets. The fluorescent polystyrene particles are excited by light of a wavelength of 530 nm and emits light of a wavelength of 607 nm, the moving particles are tracked by emitted light through a high speed camera (Photron Fastcam Mini-AX200, Japan), an actual travel distance and time are calculated by video frames, and the value of the coffee-ring flow speed U_{c} is measured based on the calculated actual travel distance and time, using a PIVlab tool in a MATLAB program, thereby obtaining the coffee-ring flow speed. Herein, the added fluorescent particles have a negatively charged zeta potential (−15±5 mV) and do not cause agglomeration with CNC (−33.9±5.3 mV) and GNR (−5.3±4.6 mV) particles which are identically negatively charged or neutral, and since the fluorescent particles are added only in a small amount of 1% v/v, it is considered that there is almost no difference from a CNC-GNR droplet evaporation mechanism.

To be described in more detail with reference to FIG. 2, when the ink for an anti-icing film of the present invention is dropped onto the solid substrate, a dotted circle is formed, and the dotted line becomes a contact line between the ink droplet formed after dropping and the substrate. As the binary mixed solution included in the ink of the present invention evaporates, the contact line moves to the droplet center, and the speed herein is referred to as a dewetting speed (U_{d}).

Simultaneously, a speed at which a coffee-ring flow occurs in the contact surface of the ink droplet formed after being dropped onto the substrate and the solid substrate is referred to as a coffee-ring flow speed (U_{c}). Since the speed is a vector quantity having direction and magnitude and U_{d} and U_{c} are in opposite directions, a ratio between the two speeds is expressed as an absolute value.

More specifically, the ink for an anti-icing film may satisfy 1≤|U_{d}/U_{c}|<3, 1≤|U_{d}/U_{c}|<2.5, 1≤|U_{d}/U_{c}|<2, 1≤|U_{d}/U_{c}|<1.7, or 1<|U_{d}/U_{c}|≤1.5, in an initial evaporation section of evaporation time/total evaporation time of 0.25.

In particular, it is important in the present disclosure to satisfy the above equation in a time zone where the ink for an anti-icing film has evaporation time/total evaporation time of 0.25 or less, and the meaning of evaporation time/total evaporation time of 0.25 or less is a time zone in the initial evaporation section in the total evaporation time.

In addition, when a section where |U_{d}/U_{c}| is less than 1 occurs even partially in the entire evaporation section, it may be difficult to form a film having a uniform pattern.

|U_{d}/U_{c}|≥1 of Equation 3 means that the dewetting speed (U_{d}) in initial evaporation is the same as or somewhat higher than the coffee-ring flow speed (U_{c}), when |U_{d}/U_{c}|≥1 is satisfied, bonding of the cellulose nanocrystal and the anisotropic gold nanorods occurs while the solvent evaporates, self-assembling proceeds near the contact line between the moving ink droplets and the solid substrate, and also, a uniform pattern of the cellulose nanocrystal and the anisotropic gold nanorods may be finally formed. In addition, when the ink satisfies Equation 3, the evaporation speed of the binary mixed solution is increased, so that the binary mixed solution may rapidly evaporate within 10 to 20 minutes.

The coffee-ring effect refers to a phenomenon in which solutes or fine particles inside a liquid flock to the outside of the liquid and are deposited, when the liquid is dried. To be described in detail, a ring shaped may be formed by a coffee-ring effect formed by occurrence of an evaporation-operation capillary flow in a contact line direction by a non-uniform evaporation rate occurring along a liquid-gas interface of the droplets. Due to the coffee-ring effect, a deposition pattern formed on a substrate becomes non-uniform, and the non-uniform deposition pattern is a cause of degrading plasmonic performance of gold nanorods.

However, the ink satisfying Equation 3 of the present disclosure allows manufacture of a CNC-GNR pattern in a growth ring shape by balancing between the coffee-ring flow speed in the contact line direction (outward direction) and the dewetting flow in the droplet center direction (inward direction) in the step of evaporating the binary mixed solution from the coated ink, in which the dewetting speed is within 0-10 μm/s and the CNC particles may be aligned to be parallel to the contact line within the speed range.

That is, the binary mixed solution satisfying Equation 3 of the present disclosure does not cause the coffee-ring phenomenon along a liquid-gas interface, and does not need a separate additive or an external energy source so that the coffee-ring phenomenon does not occur. In addition, an effect of self-assembling the anisotropic gold nanorods to the cellulose nanocrystal continuously and performing alignment on the quadrant of the film, without a stick-slip phenomenon which is a droplet contact line retreat phenomenon, by (i) a hydrophilic surface of the cellulose nanocrystal particles, (ii) a relatively low cellulose nanocrystal concentration near the contact line, and (iii) rapid evaporation of the first solvent may occur, and the thickness of the manufactured film may be formed to be uniform.

In an exemplary embodiment of the present disclosure, in order to satisfy the equation of |U_{d}/U_{c}|≥1, the first solvent having a higher vapor pressure may be more included in the added binary mixed solution than the second solvent, and specifically, the first solvent may be included at 50 vol % or more, 55 vol % or more, 60 vol % or more, or 65 vol % or more.

More specifically, a volume ratio of the first solvent/second solvent included in the binary mixed solution may be 1 to 4, and still more specifically 1 to 3, but is not necessarily limited thereto, and the volume ratio may be appropriately selected depending on the type of first solvent and second solvent satisfying Equations 1 and 2.

As an example, the first solvent of the binary mixed solution included in the ink may include methanol and the second solvent may include water, and in the mixed solution of water and methanol, the methanol may be included at 50 vol % or more and 80 vol % or less of 100 vol % of the binary mixed solution.

That is, the manufacturing method of the present disclosure may prevent the coffee-ring phenomenon along the liquid-gas interface without a separate additive or an external energy source during film manufacture, thereby providing an anti-icing film having improved plasmonic performance by forming a metasurface pattern having high uniformity.

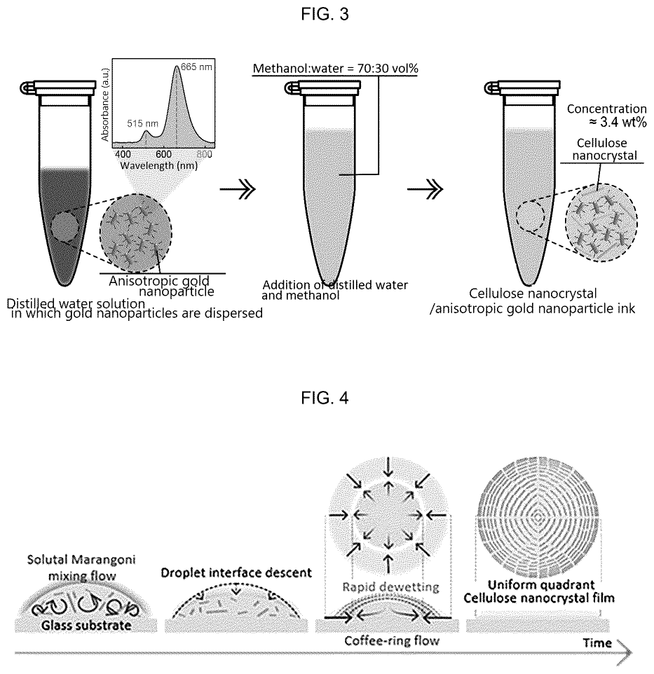

Hereinafter, the step (a) of preparing an ink will be described in detail referring to FIG. 3. The step of preparing an ink may include a dispersion preparation process and an ink preparation process.

First, in the dispersion preparation process, anisotropic gold nanorods are dispersed in the second solvent having lower vapor pressure or water to prepare a dispersion.

In the ink preparation process, a binary mixed solution including the first solvent and the second solvent is added to the dispersion prepared above, the dispersion and the binary mixed solution are mixed and stirred, and cellulose nanocrystal particles are added. Thereafter, a dispersion process may proceed to prepare a solution. In order to disperse the gold nanorods and the cellulose nanocrystal particles well in a solvent, a predetermined dispersant is added or a ultrasonic dispersion process may be performed, but the present disclosure is not necessarily limited thereto, and any dispersion method such as a physical method and a chemical method may be used without limitation as long as it is a dispersion method for preventing a physical agglomeration phenomenon of solutes.

Since the properties of the cellulose nanocrystal and the anisotropic gold nanorods, such as diameter, aspect ratio, and binary mixed solution are as described above for the anti-icing film or the ink for anti-icing film described above, description will be omitted.

Hereinafter, the step of forming a film layer of (b) and the drying step of (c) will be described in detail.

In an exemplary embodiment of the present disclosure, the method of coating a substrate with the ink may be performed by a method selected from the group consisting of spin coating, spray coating, dip coating, drop-casting, inkjet printing, nozzle printing, slot die coating, roll-to-roll printing, doctor blade coating, screen printing, and combinations thereof.

Specifically, the method may be performed by a method selected from the group consisting of dip coating, drop-casting, inkjet printing, nozzle printing, and slot die coating, and more specifically, the method may be performed by dropping (dripping) an ink onto a substrate by the drop-casting method, but is not necessarily limited thereto.

Upon review of the drying step of (c), the step of (c) evaporating the binary mixed solution from the coated ink may proceed at room temperature under normal pressure, and the room temperature may be 25±5° C. and the normal pressure may be 1 atm. However, the present disclosure is not necessarily limited thereto, and the drying process does not proceed at a high temperature or under a low pressure depending on the type of solvent of the binary mixture.

Hereinafter, the process of drying the binary mixed solution from the ink satisfying Equation 3 will be described in detail referring to the drawing.

In an exemplary embodiment of the present disclosure, in the drying step, the cellulose nanocrystal-anisotropic gold nanorod composite particles which are obtained by self-assembling the anisotropic gold nanorods to the cellulose nanocrystal and are self-assembled on the quadrant of the film may be aligned parallel to the length direction.

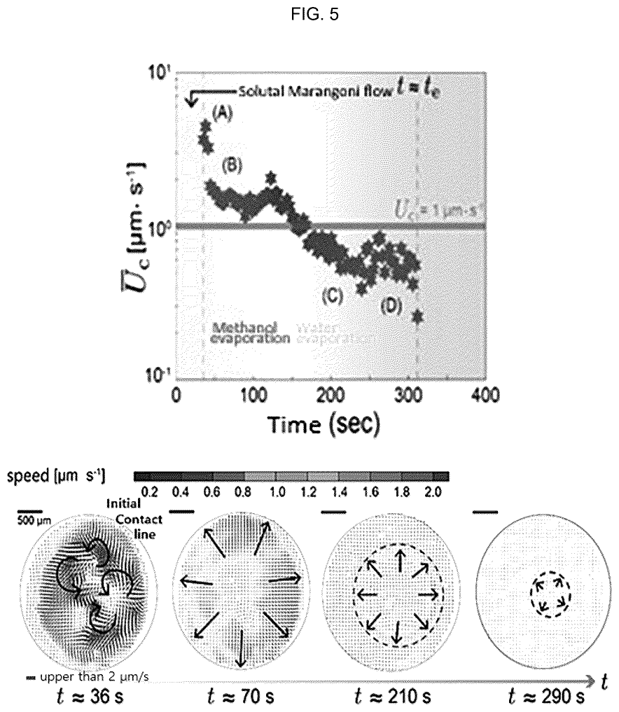

FIG. 4 schematically shows an evaporation hydrodynamical mechanism of the binary mixed solution from the ink, and FIG. 5 shows results of image measurement with a particle image flow meter.

When ink droplets are formed on the solid substrate, the first solvent having a higher evaporation speed of the binary mixed solution evaporates selectively and rapidly to cause separation of the mixed solution near the contact line, and also, generate a Marangoni stress by the Marangoni effect. As a result, a solutal Marangoni mixing flow is formed at the beginning of solvent evaporation, and descent of the droplet interface may occur.

Subsequently, a spontaneous and rapid dewetting phenomenon and a coffee-ring flow occur near the contact line, and the self-assembly of the cellulose nanocrystal particles and the anisotropic gold nanorods may proceed near the contact line where the dewetting speed (U_{d}) is the same as or somewhat more rapid than the coffee-ring flow speed (U_{c}), that is, |U_{d}/U_{c}|≥1, is satisfied.

Referring to FIG. 5, the dewetting flow and the coffee-ring flow occur after the solutal Marangoni flow disappears, and the cellulose nanocrystal particles may be self-assembled near the contact line (contact line indicated by a dotted line) satisfying |U_{d}/U_{c}|≥1.

FIG. 6 shows a polarized image when only the cellulose nanocrystal particles were dispersed in the binary mixed solution of the present invention and then the dispersion was dropped and evaporated. It is confirmed that the cellulose nanocrystal particles in the drying process are aligned parallel to the contact line in the long axis direction, as shown in FIG. 6.

In order to describe the mechanism of pattern formation in detail, referring to FIG. 5, the Marangoni flow rapidly occurs at the beginning of evaporation, and after the Marangoni flow disappears, the coffee-ring flow speed (U_{c}) rapidly occurs at a speed of 1 μm/s or more. It is seen that when the cellulose nanocrystal particles are self-assembled parallel in the long axis direction from the contact line and the position of the self-assembly of the cellulose nanocrystal particles approaches the droplet center, the coffee-ring flow speed (U_{c}) becomes less than 1 μm/s (t=210 s), and when the evaporation nears completion, the coffee-ring flow speed (U_{c}) approaches to 0.1 μm/s(t=290 s). The phenomenon may be confirmed from speed measurement of FIG. 5.

Therefore, in the process of evaporating the binary mixed solution from the ink including the cellulose nanocrystal particles, the anisotropic gold nanorods, and the binary mixed solution in which the particles and the nanorods are dispersed, the cellulose nanocrystal particles and the anisotropic gold nanorods may be co-self-assembled, and the anti-icing film manufactured from the components and the ink including the contents of the components may provide a coating layer having a metasurface in which the composite of the cellulose nanocrystal particles and the anisotropic gold nanoparticles is arranged parallel to the liquid interface in the length direction.

In an exemplary embodiment of the present disclosure, after step (c), a step of forming a waterproof layer may be further included.

The material forming the waterproof layer is not limited as long as it may impart waterproof properties. Specifically, the waterproof layer may be formed of an impermeable material. “Impermeable” means that water, moisture, and humidity do not substantially pass through or penetrate, and the impermeable material may be nonporous and/or porous. When the impermeable material is a porous material, a minimum size of pores may be smaller than the minimum size of droplets of water, moisture, and humidity.

Otherwise, a material forming the waterproof layer may have an oil or wax component having hydrophobic properties. Since the oil or wax has lipophilic properties of not mixing with moisture, it may have hydrophobic properties. Specifically, the oil may include at least one of fluorinated carbon oil, silicon oil, carbon-based oil, and fatty acid amide, and may be a manicure oil (Lucid Nail Polish, MISSHA, KOREA).

By further including the waterproof layer in the anti-icing film, the pattern formed by the anisotropic gold nanorods may have improved water resistance. FIG. 16 is results of a waterproof test of the anti-icing film of the present invention further including a waterproof layer. Referring to FIG. 16, in the case in which the waterproof layer is not included on the surface of the film, when the film is exposed to moisture, the pattern in which the cellulose nanocrystal and the anisotropic gold nanorods are co-self-assembled may be deformed, but in the case in which the waterproof layer is included, the pattern formed by the anisotropic gold nanorods is not deformed and is fixed even when the film is exposed to the moisture, thereby providing a film having improved durability.

In an exemplary embodiment of the present disclosure, the anti-icing film manufactured by the method for manufacturing an anti-icing film may satisfy the following Equation 4:

$$1 < \frac{Te}{Tc} < 2 \qquad [ Equation 4 ]$$

wherein Te is a thickness at an edge of the obtained film, and Tc is a thickness at the center of the obtained film.

The anti-icing film satisfying Equation 4 may be manufactured from the ink satisfying Equations 1 to 3 of the present invention. In the anti-icing film satisfying Equation 4, the bonded body is uniformly aligned, in which the anisotropic gold nanorods are bonded to the cellulose nanocrystal particles and self-assembled, so that a plasmonic effect may be amplified.

The Te/Tc value may be more than 1 and less than 2. When the value is satisfied, it is favorable to obtain the plasmonic photothermal effect of the anti-icing film.

FIG. 10 shows a profile of observation of the thickness of the present invention and observation of the thicknesses in the horizontal direction and the vertical direction of the film. The thickness of the film manufactured according to the method for manufacturing an anti-icing film of the present disclosure shows almost no difference between the thickness in the film center and the thickness in the film edge. That is, according to the manufacturing method of the present disclosure, an anti-icing film having a uniform thickness may be formed.

Since the aggregate of the anisotropic gold nanorods bonded to the cellulose nanocrystal particles finally in the anti-icing film is uniformly co-self-assembled, the surface of the anti-icing film is flat, the thickness of the anti-icing film may be 7 μm or less, 5 μm or less, 2 μm or less, or 1 μm or less, and specifically, control may be performed so that a thin film of 1 to 7 μm may be formed. A film having an excellent anti-icing effect even at the thin thickness may be provided.

Therefore, the method for manufacturing an anti-icing film of the present disclosure may form a circular pattern in a uniform growth ring shape in a simple evaporation process of the binary mixture, without a complicated self-assembling coating process such as addition of a separate polymer, deformation of the surface structure of solutes, deposition for forming a self-assembled monolayers (SAMs), or layer-by-layer self-assembly use, for forming a metasurface of a circular pattern, and solve a problem of a complicated manufacturing process. In addition, the method is appropriate for mass production under a large scale production system in using simple and rapid evaporation under room temperature/normal pressure conditions, and has no risk of including impurities during coating, due to the simplified process.

Hereinafter, the present disclosure will be described in detail through the examples in order to aid understanding of the present disclosure. However, the examples according to the present disclosure are not limited to the examples described herein and may be modified in various other forms, and the scope of the present disclosure should not be construed as being limited by the following examples. The examples of the present disclosure are provided for describing the present disclosure more completely to a person with ordinary knowledge in the art, and are provided for sufficiently conveying the spirit of the present disclosure to a person skilled in the art.

### Example 1

### 1) Preparation of Cellulose Nanocrystal (CNC)

Microcrystalline Cellulose (Sigma-Aldrich product) was hydrolyzed with a 64% sulfuric acid aqueous solution at 45° C. for 60 minutes, and then cooled using deionized water. The cooled microcrystalline cellulose was centrifuged and washed 5 times, pristine cellulose nanocrystals were separated, and then the nanocrystals were freeze-dried to prepare CNC particles.

### 2) Preparation of Anisotropic Gold Nanorods

Anisotropic gold nanorods were synthesized by seed-mediated growth. HAuCl₄ (mM, 5 mL) and a cetyltrimethylammonium bromide (CTAB) solution (0.2 M, 5 mL) were mixed in a vial. The Au(III)-CTAB solution prepared therefrom was centrifuged at 9000 rpm for 20 minutes to remove a supernatant, and then the solution was redispersed in 1 mL of deionized water. The centrifugation process and the process of redispersing in deionized water were repeated 2 more times in order to lower the concentration of CTAB. To the Au(III)-CTAB solution prepared above, 15 mg/mL of polyethylene glycol having a thiol group (mPEG-SH, Aldrich product, molecular weight: 6 kDa) was added, and mixing was performed at room temperature for 30 minutes. The mixed solution was allowed to stand at room temperature for 24 hours, centrifugation was performed at 9000 rpm for 20 minutes to remove an excessive amount of reagent, and the polyethylene glycol-gold nanodispersion was purified to prepare the anisotropic gold nanorods.

The anisotropic gold nanorods prepared at this time had a diameter of 16 nm and a length of 50 to 80 nm.

### 3) Preparation of Anti-Icing Film

### (a) Preparing Ink

### i) Preparation of Dispersion

0.0025 g of the anisotropic gold nanorods was added to 2.4925 g of distilled water, and then the solution was dispersed using a vortex mixer to prepare a dispersion.

### ii) Preparation of Ink

14.5775 g of the binary mixed solution in which 30 vol % of distilled water and 70 vol % of methanol were mixed was added to the dispersion, dispersion was performed using a vortex mixer, 3.40 wt % (0.6009 g) of the cellulose nanocrystal particles prepared above was added thereto, and ultrasonic dispersion was performed with an ultrasonic disperser (Branson 1510, Branson Ultrasonics, USA) to prepare an ink.

### (b) Coating Step

2 to 3 μL of the ink prepared above was dropped once onto a solid substrate by a drop-casting method to form a round droplet.

### (c) Evaporation of Binary Mixed Solution and Manufacture of Film

After the coating step, drying was performed under room temperature and normal pressure conditions to evaporate the binary mixed solution. A film having a pattern formed on the substrate, in which the cellulose nanocrystal and the anisotropic gold nanorods were uniformly co-self-assembled, was obtained. The Te/Tc of the obtained film was 1.21.

### Example 2

### (a) Preparing Ink

### i) Preparation of Dispersion

0.005 g of the anisotropic gold nanorods was added to 4.985 g of distilled water, and then the solution was dispersed using a vortex mixer to prepare a dispersion.

### ii) Preparation of Ink

12.085 g of the binary mixed solution in which 30 vol % of distilled water and 70 vol % of methanol were mixed was added to the dispersion, dispersion was performed using a vortex mixer, 3.40 wt % (0.601 g) of the cellulose nanocrystal particles prepared above was added thereto, and ultrasonic dispersion was performed with an ultrasonic disperser (Branson 1510, Branson Ultrasonics, USA) to prepare an ink.

The process was performed in the same manner as in Example 1, except the step (a). The Te/Tc of the obtained film was 1.20.

### Example 3

A film of 4×4 cm² was manufactured by dropping 1.5 mL of the ink prepared by the drop-casting method onto a solid substrate in the same manner as in Example 1, except that in the ink preparation step, the ink included the components at a weight ratio [water:methanol:ethanol:CNC:GNR=33.8758:44.8506:17.8723:3.3978].

### Example 4

A film of 4×4 cm² was manufactured by dropping 1.5 mL of the ink prepared by the drop-casting method onto a solid substrate in the same manner as in Example 1, except that in the ink preparation step, the ink included the components at a weight ratio [water:methanol:IPA:CNC:GNR=33.8989:44.8811:17.8165:3.4001].

### Comparative Example 1

The process was performed in the same manner as in Example 1, except that 93.83 g of 100% distilled water was added to the dispersion. The Te/Tc of the obtained film was 7.05.

### Comparative Example 2

The process was performed in the same manner as in Example 1, except that 93.83 g of the binary mixed solution in which 70 vol % of distilled water and 30 vol % of methanol were mixed was added. The Te/Tc of the obtained film was 4.71.

### Comparative Example 3

The process was performed in the same manner as in Example 1, except that only GNR was included and no CNC was included in 70 vol % of methanol and 30 vol % of water.

### Experimental Example 1: Spontaneous Metasurface Formation Mechanism in Drying Step

A phenomenon in which the cellulose nanocrystal particles were self-assembled in the evaporation process of the binary mixed solution was observed using a polarizing optical microscope (POM, Nikon Eclipse Ti2-E microscope, and DS-Ri2 detector, Japan).

FIG. 4 is a schematic diagram showing an ink droplet evaporation hydrodynamic mechanism during a process in which the binary mixed solution evaporates from the ink of the present disclosure.

Referring to FIG. 5 in order to describe the mechanism in detail, it was found that the solutal Marangoni flow rapidly occurred at the beginning of evaporation of the ink, a coffee-ring flow occurred rapidly at a speed of 1 μm/s or more after the Marangoni flow disappeared, the cellulose nanocrystal particles were self-assembled from the contact line, the coffee-ring flow speed (U_{c}) became less than 1 μm/s when the position of self-assembly of the cellulose nanocrystal particles approached the droplet center, and the coffee-ring flow speed (U_{c}) approached 0.1 μm/s when the evaporation approached completion. The phenomenon may be confirmed from speed measurement of FIG. 5. The schematic representation of the polarized image of FIG. 6 which was a self-assembled final state of the cellulose nanocrystal may be shown as in FIG. 4.

That is, it was confirmed that when a film was manufactured by the ink for an anti-icing film of the present disclosure, the co-self-assembly of the cellulose nanocrystal and the anisotropic gold nanorods was able to be uniformly performed within a short time without an external energy source, and a circular metasurface was able to be spontaneously formed on a substrate without a separate pattern formation process on the substrate.

### Experimental Example 2: Metasurface Pattern Depending on Magnitude of |U_{d}/U_{c}|

A polarized image in which the cellulose nanocrystal particles were self-assembled in the evaporation process of the binary mixed solution having different ratios of the first solvent and the second solvent was observed using a polarizing optical microscope (POM, Nikon Eclipse Ti2-E microscope, and DS-Ri2 detector, Japan).

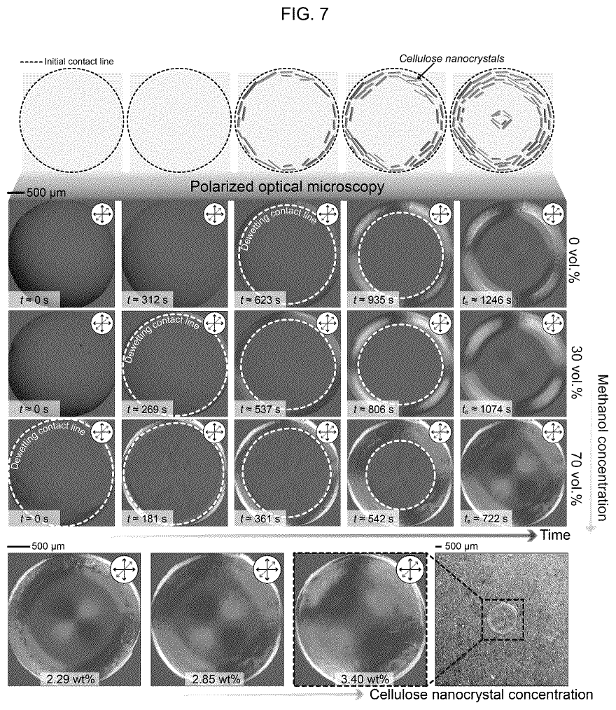

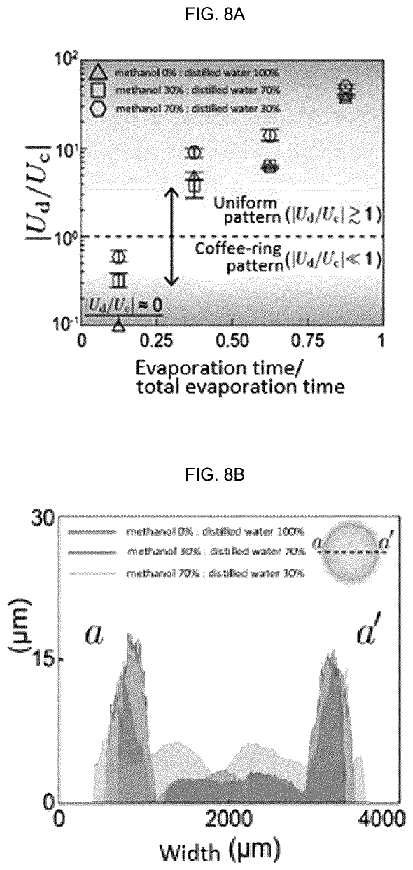

FIGS. 7 and 8A shows a polarized image of cellulose nanocrystal particles which were self-assembled by dispersing 2.85 wt % of the cellulose nanocrystal particles in the binary mixed solution including the second solvent (water) and the first solvent (methanol), dropping the dispersion onto the substrate to form droplets, and then evaporating the solvent (FIG. 7) and |U_{d}/U_{c}| depending on an evaporation time (FIG. 8A).

Referring to FIG. 7, when the binary mixed solution was formed of 100% water, the solvent evaporated and the cellulose nanocrystal particles were self-assembled, and crystal growth (The bright spot in FIG. 7) started after 10 minutes. It was found that as the content of the first solvent (methanol) having a higher vapor pressure was increased in the binary mixed solution, a crystal growth time was shortened. In particular, it was confirmed that when the content of methanol included in the binary mixed solution was 70 vol %, the self-assembly of the cellulose nanocrystal started at the beginning of evaporation, and the time of crystal growth completion by the self-assembly of the cellulose nanocrystal on the quadrant was significantly shortened as compared with the crystal growth time of the ink formed of 100% water.

In FIG. 8A, in order to review the effect of a methanol concentration on drying uniformity of U_{d}/U_{c} and the cellulose nanocrystal film, variables other than the methanol concentration were set to be equal and comparison experiment was performed. A shadow mask having a circular hole of 3 mm on the lower substrate (glass) was attached to the substrate so that the size of droplets was identically formed to be 3 mm, and then a hydrophilic surface treatment was performed. A little retardation of a dewetting starting point of the evaporated droplets may occur in every case due to the surface treatment.

FIG. 8A is a graph showing a change in |U_{d}/U_{c}| depending on the methanol content included in the binary mixed solution. The reason that |U_{d}/U_{c}| showed a value significantly larger than 1 was that the evaporation of the solvent approached to completion and U_{c} showed a speed of less than 1 μm/s (points (t=210 s) and (t=290 s) in FIG. 5). That is, when the dewetting speed (U_{d}) at which the droplets in the contact line retreated in the center direction was somewhat higher than or the same as the coffee-ring flow speed (U_{c}) at which the contact line was improved in the droplet center, the self-assembly of the cellulose nanocrystal was formed uniformly. The dewetting speed (U_{d}) which is somewhat higher than or the same as the coffee-ring flow speed (U_{c}) at which the contact line was improved in the droplet center may be quantitatively expressed as 1≤|U_{d}/U_{c}|<2, 1≤|U_{d}/U_{c}|<1.7, or 1≤|U_{d}/U_{c}|≤1.5.

FIG. 8B shows the results of examining the change in the film thickness depending on the methanol content included in the binary mixed solution, when only the cellulose nanocrystal was dispersed in the binary mixed solution. When the binary mixed solution was formed of 100% water, the coffee-ring flow occurred dominantly, and thus, the cellulose nanocrystal particles were mainly formed near the contact line, and when methanol was included at 30 vol % and 70 vol %, respectively, in the binary mixed solution, the area in which the cellulose nanocrystal was self-assembled toward the droplet center near the contact line expanded, so that a uniform circular pattern was able to be formed even to the inside of the metasurface.

That is, it was confirmed that the mixing ratio (volume ratio) of methanol and distilled water of the binary mixed solution included in the ink acts as an important role to derive the ink satisfying |U_{d}/U_{c}|≥1.

Subsequently, 2.29 wt %, 2.85 wt %, and 3.40 wt % of the cellulose nanocrystal was dispersed, respectively, in the binary mixed solution formed of water and methanol at a volume mixing ratio of 30:70, the dispersion was dropped onto the substrate to form droplets, and the solvent was evaporated. When the cellulose nanocrystal was 2.29 wt %, 2.85 wt %, and 3.40 wt %, it was confirmed that the cellulose nanocrystal was all uniformly self-assembled on the quadrant.

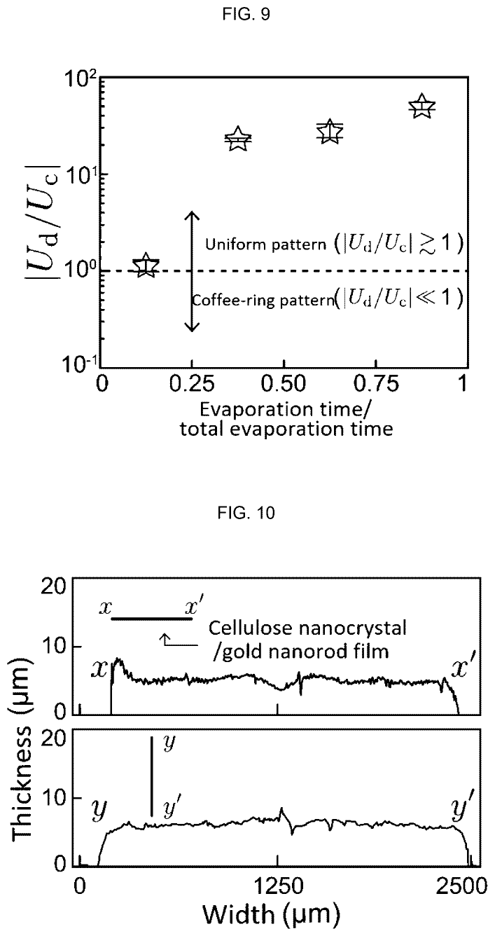

FIG. 9 shows the change in |U_{d}/U_{c}| of the ink in the process of evaporating the binary mixed solution from the ink after forming droplets from the ink including the cellulose nanocrystal and the anisotropic gold nanorods in the binary mixed solution including 30 vol % of water and 70 wt % of methanol on the solid substrate by the drop-casting method. In the experiment of FIG. 9, the results of drying the case of 70 vol % of methanol without a separate substrate surface treatment, unlike the experiment of FIG. 8A are shown, and it was confirmed that |U_{d}/U_{c}|≥1 was ideally satisfied without retardation of dewetting occurrence.

When the ratio of evaporation time (t)/total evaporation time (tₑ) was less than 0.25, that is, the ink satisfied the equation of |U_{d}/U_{c}|≥1 at the initial evaporation time, it was confirmed that the cellulose nanocrystal and the anisotropic gold nanorods were uniformly self-assembled without coffee-ring pattern formation. The reason for the |U_{d}/U_{c}| value of the ink exceeding 10 as the evaporation proceeded was that the U_{c} value was formed to be less than 1 μm/s in the section where the second solvent evaporated after the first solvent evaporated ((t=210 s) and (t=290 s)), as shown in FIG. 5.

As compared with FIG. 8A, it was found that in the case of |U_{d}/U_{c}|<1 at the time at which the evaporation time (t)/total evaporation time (tₑ) ratio was less than 0.25, a non-uniform coffee-ring pattern was formed.

It was confirmed that as the content of the first solvent having a relatively high vapor pressure was increased in the binary mixed solution, the |U_{d}/U_{c}| value had a value of 1 or more in the initial evaporation section, and the self-assembly of the cellulose nanocrystal occurred at the beginning of evaporation without forming a non-uniform coffee-ring pattern. In particular, it was found that when 70 vol % of the first solvent (methanol) was included in the binary mixed solution, a spontaneous and rapid dewetting flow was shown at the beginning of evaporation, and the cellulose nanocrystal particles were self-assembled.

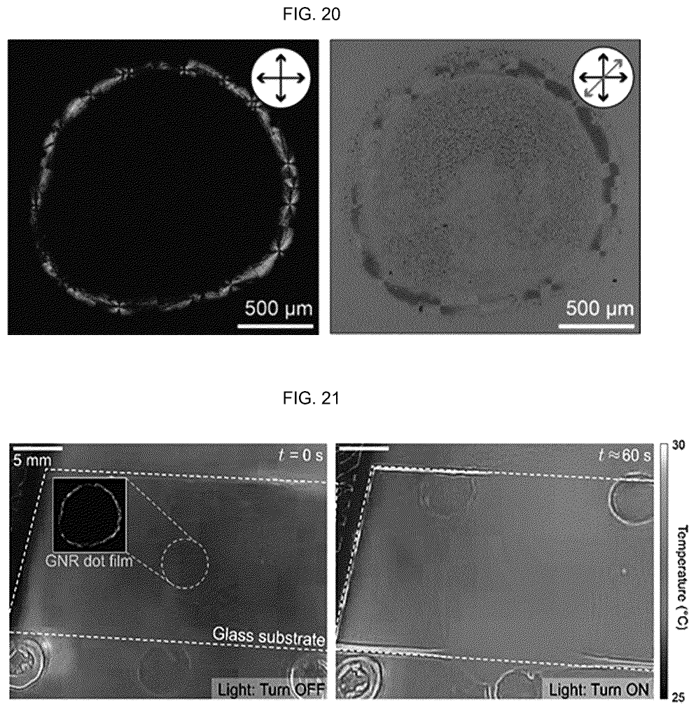

However, the pattern of Comparative Example 3 which was the film formed by adding only GNR without adding CNC and performing evaporation may be confirmed with reference to FIG. 20.

Referring to the polarizing microscopic image of FIG. 20, it was confirmed that a thin strip-shaped coffee-ring pattern was formed in Comparative Example 3, and this played an important role in forming a uniform circular pattern in the evaporation process of the cellulose nanocrystal as well as a solution for an anti-icing film having the |U_{d}/U_{c}| value of 1 or more.

### Experimental Example 3: Evaluation of Pattern Uniformity

The cellulose nanocrystal particles were dispersed in the binary mixed solution including water and methanol, the binary mixed solution was evaporated, and the pattern formed by cellulose self-assembly was analyzed using an atomic microscope (AFM, Multimode-8, Bruker, USA).

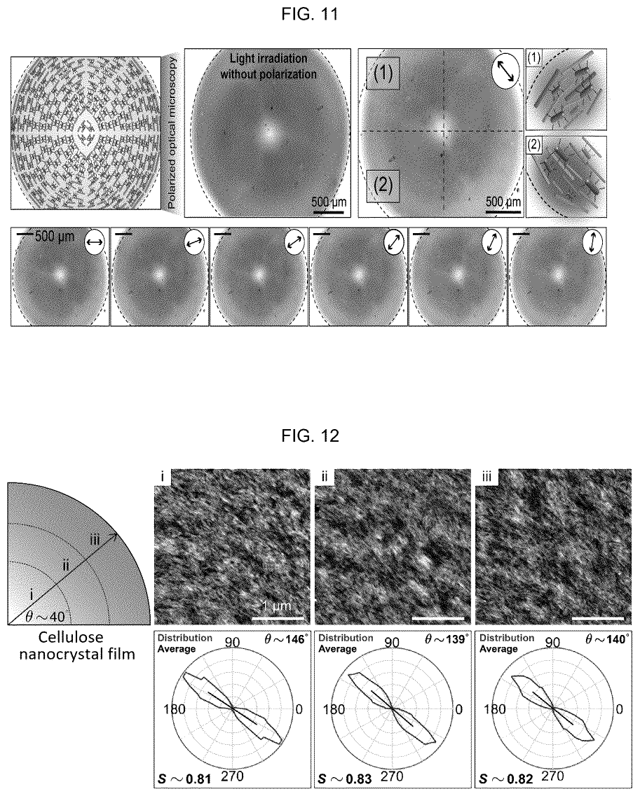

FIG. 11 shows the results of measuring the optical metasurface of the film manufactured in Example 2. Referring to FIG. 11, it was confirmed that the anisotropic gold nanorods were bonded to the cellulose nanocrystal particles and uniformly co-self-assembled to form a film including a uniform pattern. As in FIG. 11, the co-self-assembly of the cellulose nanocrystal and the anisotropic gold nanorods was uniformly aligned on the quadrant of the film.

FIG. 12 shows the distributions of the cellulose nanocrystal particles (i) near the inside of the pattern, (ii) near the middle, and (iii) near the contact line of Example 2. Referring to FIG. 12, it was confirmed that the cellulose nanocrystal particles were aligned uniformly and parallel to the contact line from the inside of the circular pattern to the contact line in the pattern.

At this time, the pattern of the gold nanorods was analyzed using a scanning electron microscope-backscatter electrons (SEM-BSE, SU-8230, Hitachi, Japan).

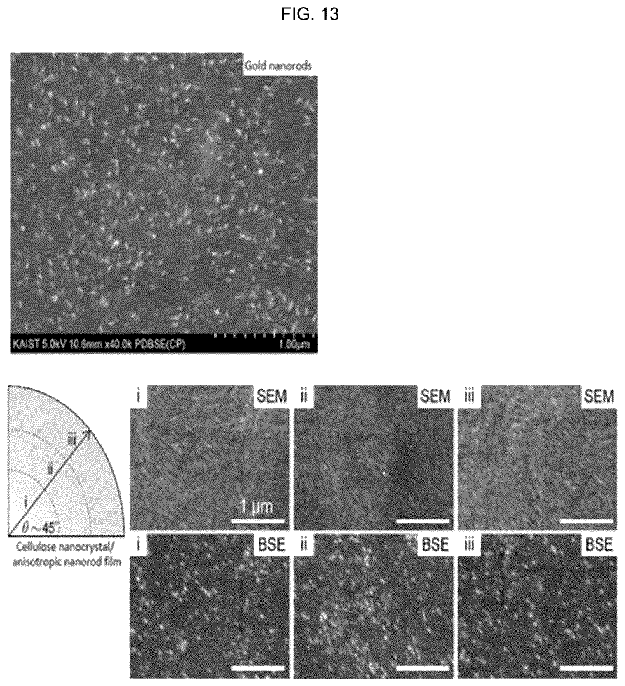

In FIG. 13 is an image of the anisotropic gold nanorods distributed in the film, and a distribution of the anisotropic gold nanorods (i) near the inside, (ii) near the middle, and (iii) near the contact line of the film. Referring to FIG. 13, since the anisotropic gold nanorods were bonded to the cellulose nanocrystal particles and uniformly co-self-assembled, it was confirmed that the cellulose nanocrystal particles and the anisotropic gold nanorods were oriented parallel to the contact line.

Thus, it was confirmed that the metasurface of the anti-icing film of the present disclosure included the pattern in which the cellulose nanocrystal and the anisotropic gold nanoassembly were aligned parallel to the circumferential direction and uniformly on the quadrant of the film layer.

### Experimental Example 3: Temperature Change Test Depending on GNR Content

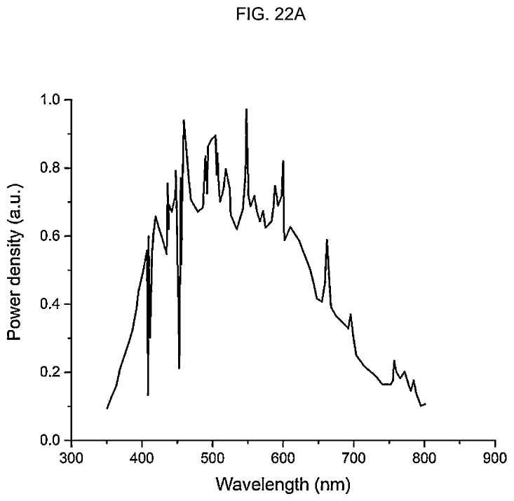

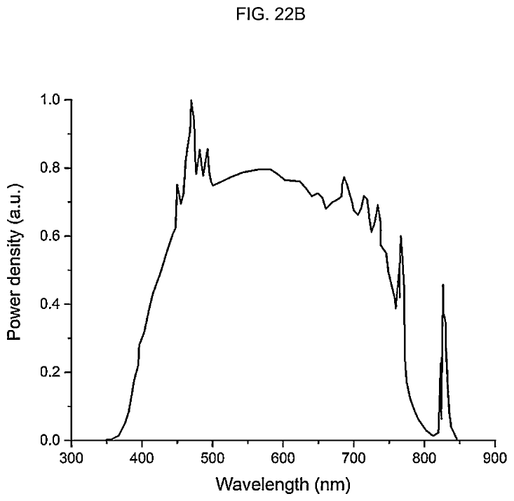

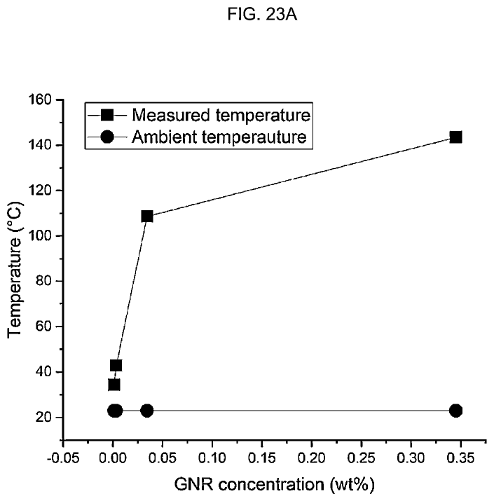

Binary mixed solutions were prepared as in Example 1, in which the concentration of the anisotropic gold nanorods were gradually increased to 0.00132 wt %, 0.00346 wt %, 0.03462 wt %, and 0.34515 wt %, the solutions were applied on a transparent GLASS surface, the solution was evaporated under simple room temperature/normal pressure conditions to manufacture a large area pattern (about 4×4 cm²), and photothermal performance depending on GNR concentration was tested. At this time, irradiation was performed with a light source having the same wavelength spectrum as FIG. 22A, and the light intensity was about 356.5 mW/cm².

Referring to FIG. 17A, it was confirmed that as the content of GNR was increased from 0 to 0.35 wt %, the plasmon heating effect was increased to increase a surface temperature, and when the content reached 0.35 wt %, the film surface temperature was heated to about 100° C.

At this time, light intensity was gradually increased and the film surface temperature was measured. Referring to FIG. 17B, it was confirmed that as the light intensity was increased, a linear temperature increase/decrease pattern was shown. This means an increase of about 18° C. (light irradiation conditions of 53.5 mW/cm²) as compared with surrounding temperature (23° C.) even under light (8.56 to 67.62 mW/cm²) conditions at the level of solar radiation energy reaching earth's surface.

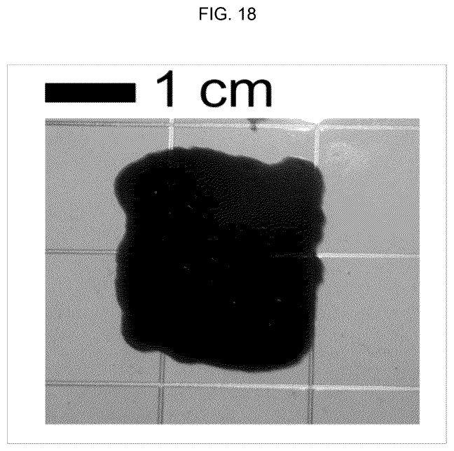

In addition, it was confirmed that as the content of GNR increased, the surface of the film changed from transparent or achromatic (black) as in FIG. 18, and due to the phenomenon, the absorbance in the visible light region of the anti-icing film was increased to amplify the light emitting effect.

Therefore, the temperature rise rate and transparency according to light irradiation were able to be controlled, depending on the content of GNR during the manufacture of the anti-icing film of the present disclosure.

### Experimental Example 4: Evaluation of Anti-Icing Film Performance

### 1) Measurement of Film Thickness

In order to evaluate the deposition uniformity of the film of the present invention, a deposition thicknesses in the vertical direction and the horizontal direction were measured using a confocal laser scanning microscope (VK-X1050, Keyence, Japan).

### 2) Measurement of Temperature Change, Icing, and Deicing

The anti-icing films manufactured according to Examples 1 and 2 and Comparative Examples 1 and 2 were manufactured into samples of 4×3 array, and the test was performed by changing their temperature to the range of −15° C. to −8° C., using a temperature control stage (LTS420, Linkam, UK). The stage was cooled with liquid nitrogen, and in order to confirm the temperature distribution, a thermal imaging camera (FLIR A35, Teledyne FLIR, USA) was used for observation.

### 3) Film Waterproof Test

10 mL of water was sprayed on the surface of a film including a waterproof layer and a film including no waterproof layer, and then the surface structures of the two films after 3 minutes were compared and analyzed by a polarizing microscope.

The total evaporation time required to obtain the anti-icing film from the examples and the comparative examples and the temperature rise degree were measured and are summarized in Table 1.

TABLE 1

| | | Total | | Occurrence | | |
|---|---|---|---|---|---|---|
| | \| U_{d}/ | evaporation | Te/ | of coffee- | Temperature | |
| | U_{c} \| | time | Tc | ring | rise | |
| Example 1 | >1 | 410 seconds | 1.21 | x | 3° | C. |
| Example 2 | >1 | 410 seconds | 1.20 | x | 5° | C. |
| Example 3 | >1 | 21600 | 1.00 | x | 7° | C. |
| | | seconds | | | | |
| Example 4 | >1 | 21600 | 1.15 | x | 9.3° | C. |
| | | seconds | | | | |
| Comparative | <1 | 1200 | 7.05 | ∘ | 1° | C. |
| Example 1 | | seconds | | | | |
| Comparative | <1 | 1100 | 4.71 | ∘ | 1.5° | C. |
| Example 2 | | seconds | | | | |

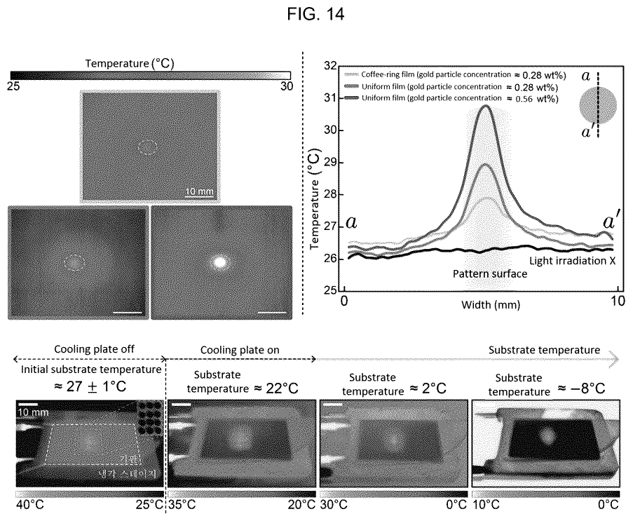

FIG. 14 shows changes in film surface temperature observed when the anti-icing film of the present invention (Example 2) was placed on a substrate having a film initial temperature of 27±1° C., and the anti-icing film was irradiated with light in the visible light wavelength section of 350 to 800 nm (light source having the wavelength spectrum as in (a) of FIG. 22) at an intensity of 500±50 mW/cm² for 270 seconds.

At this time, the surface temperature of the anti-icing film of Example 2 was raised by 3 to 5° C. When the temperature of the substrate on which the heated anti-icing film was placed was gradually cooled to 27±1° C., 22° C., 2° C., and −8° C., it was confirmed that the decrease rate of the surface temperature of the film was decreased and a difference in temperatures between the substrate and the film was more than 10° C.

However, a coffee-ring occurred in the metasurface of Comparative Examples 1 and 2, and when irradiation was performed with light in the visible light wavelength, the temperature rise was 1 to 1.5° C., which was significantly lower temperature rise than the examples of the present disclosure. This was due to the fact that the anti-icing film of the present disclosure had high absorbance in the visible light region and amplified heating by a plasmon resonance phenomenon.

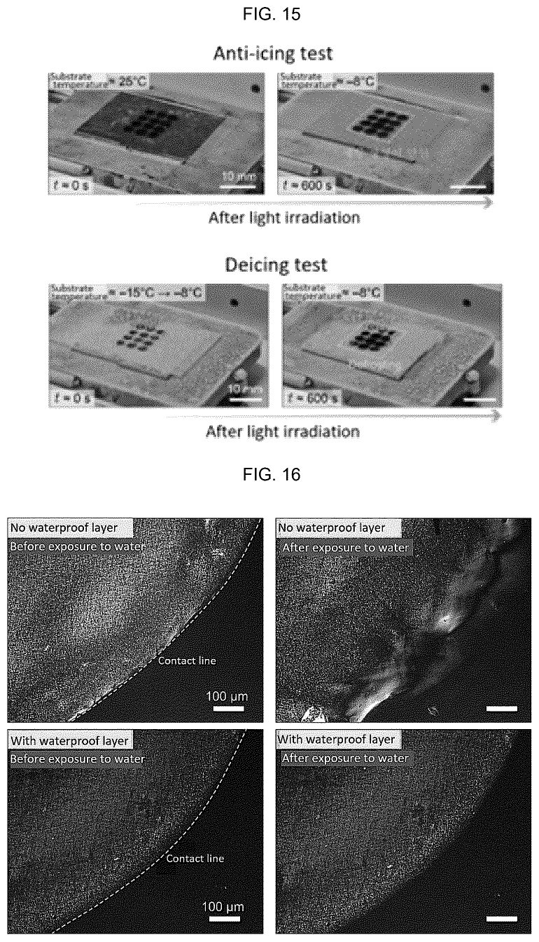

FIG. 15 shows the results of anti-icing and deicing tests of the anti-icing film prepared according to Example 2. When the substrate on which the anti-icing film of the present disclosure was placed was cooled to −8° C., the film surface was not frozen, and the film surface was not deiced only with irradiation of light in the visible light wavelength region of 350 to 800 nm at an intensity of 50 mW/cm² for 600 seconds.

In addition, the substrate on which the anti-icing film of the present invention was placed was cooled to −15° C., the temperature was changed to −8° C., and the film surface was not frozen only with irradiation of light in the visible light wavelength region of 350 to 800 nm at an intensity of 500±50 mW/cm² for 600 seconds.

When the binary mixed solution satisfying Equations 1 to 3 were included (Examples 1 to 4), the evaporation time of the binary mixed solution was significantly shortened, the coffee-ring phenomenon did not occur, and the temperature rise (heating effect) was effective, as compared with the case of including only distilled water (Comparative Example 1). In particular, a film manufactured from the ink satisfying |U_{d}/U_{c}|≥1 had a uniform thickness and satisfied

$$1 < \frac{Te}{Tc} < 2.$$

In addition, it was confirmed that the film manufactured from the ink had excellent anti-icing and deicing effects.

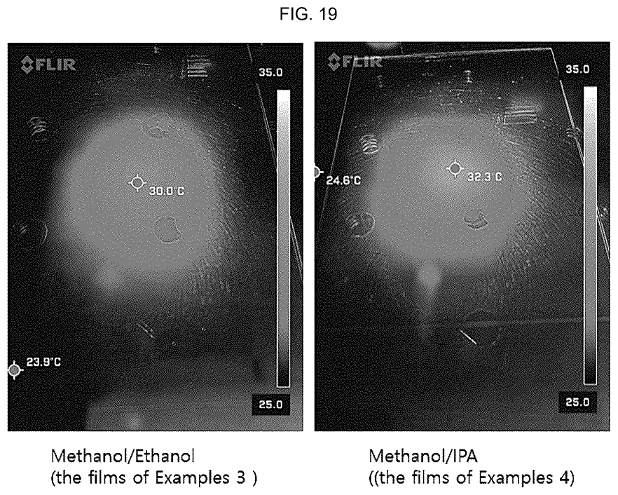

In addition, in Examples 3 and 4, the evaporation time was measured somewhat long as compared with Examples 1 and 2, but as a result of satisfying Equations 1 to 3, it was confirmed that the coffee-ring did not occur. In addition, referring to FIG. 19, evaluation of the photothermal performance of CNC-GNR film (Examples 3 and 4) was confirmed. After light irradiation in the visible light region at an intensity of about 356.5 mW/cm² on the films of Examples 3 and 4, the effect of temperature rise by about 7° C. and 9.3° C. as compared with the surrounding temperature was confirmed.

In addition, the heating performance of the film including only GNR without adding CNR (Comparative Example 3) is shown in FIGS. 20 and 21. Referring to FIG. 20, when evaporation was performed only with addition of the anisotropic gold nanorods, a thin strip-shaped non-uniform coffee-ring pattern was confirmed to be formed. Since the non-uniform coffee-ring-shaped pattern was formed, it was confirmed that a film area irradiated with light was rapidly decreased, and the temperature rise through the plasmonic photothermal effect was very small so that it was difficult to distinguish the temperature rise from camera background noises.

Thus, it was found that the temperature rise effect was significant in the case of the film in which the anisotropic gold nanorods were co-self-assembled to the cellulose nanocrystal and aligned uniformly parallel to the contact line (Examples 1 to 4), as compared with the film having the coffee-ring phenomenon during the manufacturing process of the anti-icing film (Comparative Examples 1 to 3). In addition, it was found that as the content of the anisotropic gold nanorods in the film was increased, the temperature rise rate of the film was proportionally increased, and the content of GNR was appropriately adjusted depending on the use of the anti-icing film. In addition, it was confirmed that the film area irradiated with light was expanded by preventing the coffee-ring phenomenon, and the plasmonic heating effect was able to be amplified using the broadband plasmonic metasurface due to the co-self-assembly of CNR-GNR.

### Experimental Example 5: Evaluation of Anti-Icing Film Performance Depending on Light Source

Unlike the light source used in Experimental Examples 3 and 4, a temperature change of the anti-icing film was measured, using a light source having a relatively higher density of light intensity in the wavelength band of 500 to 700 nm as in FIG. 22B at this time.

FIG. 23A shows graphs of a temperature change in a CNC-GNR film under a light irradiation of about 191.0 mW/cm², when a concentration of metal nanorods (GNR) included is 0.0132 wt %, 0.00346 wt %, 0.03462 wt %, and 0.34515 wt %, and FIG. 23B show a temperature rise of a film depending on light source intensity of used in Experimental Example 5.

Referring to FIG. 23B, it was confirmed that when the anti-icing film was irradiated with a light source having a higher light density in the wavelength region of 500 nm to 700 nm, higher spontaneous heat performance (temperature rise effect) was able to be induced with a lower light density.

Actually, for the concentration of the same gold nanorods of 0.35 wt %, the temperature rise was measured as about 101° C. under light irradiation at an intensity of 356.5 mW/cm² with the light source FIG. 22A, and the temperature rise was shown as about 143.5° C. with a light source at a lower intensity of 191.0 mW/cm² with the light source of FIG. 22B.

It was confirmed that the temperature rise effect was shown with the yellow light source having a high density in the wavelength band of 500 to 700 nm as well as the blue light source having a relatively high density in the wavelength band of 350 to 500 nm, and in particular, when irradiation was performed with the light source having a high density in the wavelength band of 500 to 700 nm, the temperature rise effect of the anti-icing film was excellent.

Therefore, the anti-icing film of the present disclosure generated own thermal energy by the plasmon photothermal phenomenon in the full visible light region of the wavelength of 350 to 800 nm and allowed deicing/anti-icing.

That is, the present disclosure may provide an anti-icing film which may raise temperature by a spontaneous heat energy harvesting effect to convert solar energy into heat energy, and it is expected that energy will be saved in winter car deicing, aircraft deicing, residential and commercial spaces, and the like.

According to an exemplary embodiment of the present disclosure, heating efficiency is amplified by a plasmon resonance phenomenon even in natural light through a metasurface having high absorbance in a visible light region, and thus, an anti-icing film having an excellent anti-icing and deicing effect may be provided.

The anti-icing film according to an exemplary embodiment of the present disclosure may improve the anti-icing and deicing effect even with a thinner thickness.

The method for manufacturing an anti-icing film according to an exemplary embodiment of the present disclosure does not need a separate additive or an external energy source in order to eliminate a coffee-ring phenomenon occurring along a liquid-gas interface and minimize physiochemical damage to a coating result with gold nanoparticles.

According to an exemplary embodiment of the present disclosure, an anti-icing system using an anisotropic gold nanorod film does not need surface structure deformation for forming a hydrophobic surface, does not need to spray an anti-icing liquid, and does not require a heating wire installation under a substrate.

Therefore, the present invention may provide a method for manufacturing an anti-icing film by a simple process.

Although the exemplary embodiments of the present invention have been described with reference to the accompanying drawings, those skilled in the art will appreciate that various modifications and alterations may be made without departing from the spirit or essential feature of the present invention. Therefore, it should be understood that the exemplary embodiments described above are not restrictive, but rather illustrative in all aspects.

What is claimed is:

1. An ink for an anti-icing film comprising: cellulose nanocrystal particles, anisotropic gold nanorods, and a binary mixed solution.

2. The ink for an anti-icing film of claim 1, wherein the binary mixed solution includes a first solvent and a second solvent, and the first solvent and the second solvent satisfy the following Equation 1 and Equation 2:
$${P}_{1} / {P}_{2} > 5 \qquad [ Equation 1 ]$$
$${γ}_{1} / {γ}_{2} > 3 \qquad [ Equation 2 ]$$
wherein P₁ and P₂ are vapor pressures at 20° C. of the first solvent and the second solvent, respectively, and a unit of the vapor pressure is kPa, and γ₁ is a surface tension value of a solvent having a higher surface tension of the first solvent and the second solvent, γ₂ is a surface tension value of a solvent having a lower surface tension of the first solvent and the second solvent, the surface tension value is surface tension at 25° C., and a unit of the surface tension is mN/m.

3. The ink for an anti-icing film of claim 2, wherein the first solvent includes methanol and the second solvent includes water.

4. The ink for an anti-icing film of claim 1, wherein the ink satisfies the following Equation 3 in an entire area section of evaporation time:
$$\vert {U}_{d} / {U}_{c} \vert \geq 1 \qquad [ Equation 3 ]$$
wherein U_{d} is a dewetting speed of a contact line between an ink droplet and a substrate after dropping the ink onto a solid substrate by a drop-casting method, and U_{c} is a coffee-ring flow speed in a contact surface between the ink droplet and the substrate after dropping the ink onto the solid substrate.

5. The ink for an anti-icing film of claim 1, wherein the anisotropic gold nanorods have an aspect ratio of 2 to 9.

6. The ink for an anti-icing film of claim 1, wherein the cellulose nanocrystal particles have an aspect ratio of 2 to 30.

7. A method for manufacturing an anti-icing film, the method comprising:
(a) preparing the ink of claim 1;
(b) coating a substrate with the prepared ink; and
(c) evaporating a binary mixed solution from the coated ink.

8. The method for manufacturing an anti-icing film of claim 7, wherein the ink of (a) includes 1.0 to 10.0 wt % of cellulose nanocrystal.

9. The method for manufacturing an anti-icing film of claim 7, wherein the ink of (a) includes 0.01 to 1.0 wt % of anisotropic gold nanorods.

10. The method for manufacturing an anti-icing film of claim 7, wherein the method of coating a substrate with the ink is performed by a method selected from the group consisting of spin coating, spray coating, dip coating, drop-casting, inkjet printing, nozzle printing, slot die coating, roll-to-roll printing, doctor blade coating, screen printing, and combinations thereof.

11. The method for manufacturing an anti-icing film of claim 7, wherein in the drying, the anisotropic gold nanorods are self-assembled to the cellulose nanocrystal to form a pattern of being uniformly aligned in a growth ring shape on a quadrant of the film.

12. The method for manufacturing an anti-icing film of claim 7, wherein the drying proceeds at room temperature under normal pressure.

13. The method for manufacturing an anti-icing film of claim 7, further comprising:
forming a waterproof layer, after (c).

14. An anti-icing film comprising:
a substrate; and
a film layer including a metasurface on the substrate,
wherein the metasurface includes a composite aligned in a certain direction, in which anisotropic gold nanorods and cellulose nanocrystal particles are co-assembled.

15. The anti-icing film of claim 14, wherein the metasurface has a pattern in which the composite of the cellulose nanocrystal particles and the anisotropic gold nanorods is oriented parallel in a growth ring shape on the quadrant of the film layer.

16. The anti-icing film of claim 14, wherein the cellulose nanocrystal and the anisotropic gold nanorods are included at a weight ratio of 1:0.001 to 1:1.

17. The anti-icing film of claim 14, wherein the anti-icing film generates heat only with light irradiation in a visible light region.

18. The anti-icing film of claim 14, wherein the anti-icing film satisfies the following Equation 4:
$$1 < \frac{Te}{Tc} < 2 \qquad [ Equation 4 ]$$
wherein Te is a thickness at an edge of the obtained film, and Tc is a thickness at the center of the obtained film.
